(19) United States
(12) Patent Application Publication
(10) Pub. No.: US 2026/0244704 A1
(43) Pub. Date: Aug. 20, 2026

(54) Methods and Apparatus for Determining Partial Factor Matrices

(71) Applicant: Telefonaktiebolaget LM Ericsson (publ), Stockholm (SE)

(72) Inventors: Stefan Adalbjörnsson, Austin, TX (US); Xavante Erickson, Lund (SE); Toivo Henningsson, Lund (SE)

(21) Appl. No.: 19/161,891

(22) PCT Filed: Mar. 9, 2023
(86) PCT No.: PCT/EP2023/056047

§ 371 Date: Sep. 3, 2025

(51) Int. Cl. G06F 17/16

(52) U.S. Cl. CPC G06F 17/16

(57) ABSTRACT

Methods and apparatus are provided. In some examples, apparatus for determining partial factor matrices (S) for a tree is provided. The tree comprises a plurality of nodes, each node being associated with a clique of one or more variables and having one or more child nodes and/or one or more child factors. The apparatus comprises a first module configured to provide, for a child factor of a selected node of the plurality of nodes and based on estimates of the one or more variables of the clique associated with the selected node, a linearized matrix (A) representing the child factor of the selected node; and a second module configured to provide a Hessian matrix (F) for the child factor of the selected node based on the linearized matrix (A). The apparatus also comprises a third module configured to accumulate the Hessian matrix (F) for each child factor of the selected node and a partial factor matrix (S) of any child node of the selected node to provide an accumulation matrix (P); and a fourth module configured to provide a partial factor matrix (S) for the selected node based on the accumulation matrix (P). The apparatus is arranged or controlled to select each of the plurality of nodes to determine the partial factor matrix (S) of each node.

The project leading to this application has received funding from the European Union's Horizon 2020 research and innovation programme under grant agreement No 876019.

### TECHNICAL FIELD

Examples of this disclosure relate to methods and apparatus for determining partial factor matrices, for example of a tree such as a Bayes tree or a tree based on a factor graph.

### BACKGROUND

Sparse Factor Graphs are useful to model and solve many Bayesian inference problems. One application is in simultaneous localization and mapping (SLAM), where typically a front end processes camera images to find feature points and connect them to landmarks, and then a back end sets up and solves a big sparse factor graph to estimate the position of all landmarks and the motion of the observer in relation to them. SLAM is useful for autonomous vehicles including drones and vacuum cleaner robots, and for extended reality (XR) devices, which need to make an accurate estimate of their position and orientation. In SLAM problems for example, it can be useful to set up an updated factor graph problem for each of a chosen set of frames, and make the solution of each updated problem reuse computations from the previous problem.

A factor graph describes the relationship between a number of unknown variables and a number of factors, which describe measurements that relate these variables. One variable can represent a collection of scalar variables (numbers). Each variable is represented by a node in the factor graph. Each factor connects the variables that its measurements depend on (a factor that is a relative measurement between two variables connects those two variables).

FIG. 1 illustrates an example of a factor graph. The factor graph includes five nodes that are variables, labelled p₃, p₄, p₅, l₁ and l₂. In a particular example, the variables p₃, p₄ and p₅ may represent the location of an unmanned aerial vehicle (UAV) at three different times, and l₁ and l₂ may represent landmarks that were observed by the UAV. More specifically, l₁ is seen from p₃ and p₄, and l₂ is seen from p₅. Lines between the variables represent factors. So, for example, a line between p₃ and p₄ may be a factor representing motion sensor data recorded by the UAV between these locations.

Algorithms may solve optimization problems defined on factor graphs using sparse Cholesky factorization, such as Gauss-Newton. Mathematically, one iteration of the back-end problem can be seen to involve the following steps: Linearization->Create Hessian->Cholesky factorization->Back substitution->Retraction.

Linearization results in a sparse matrix called the Jacobian, where each row represents a scalar measurement, and each column represents a scalar variable. Let A be the Jacobian. The matrix called the Hessian is computed from the Jacobian as ATA. This is a (sparse) symmetric matrix where each row/column is connected to one scalar variable. The objective is to solve a linear equation system for the variables, where the Hessian is the system matrix. The whole Hessian can be seen as the sum of one Hessian from each factor.

Cholesky Factorization computes the Cholesky factor, a matrix L such that LL^{T}=A^{T}A (approximately, since it is a numerical computation), but L is lower triangular. This means that all entries in L above the diagonal are zero. Cholesky factorization is carried out by eliminating one variable at a time. The triangular structure of the L matrix makes it straightforward to solve the linear equation system through a process called back substitution, once the whole L matrix has been computed.

In most factor graph problems, factors are connected only to a few variables, and most variables are directly connected to only a limited number of variables through factors. This makes the factor graph problem, and the Jacobian and Hessian matrices, sparse. In such sparse problems, it is typically vital to exploit the sparsity and to preserve it as much as possible; otherwise, the computation time, memory requirements, etc. will be drastically greater. The Cholesky Factor will typically also be sparse, but how sparse depends on the selection of a good elimination order for the Cholesky Factorization.

Dense (non-sparse) matrix computations have a very regular structure. Sparse matrix computations in general have a much less regular structure, but it can be important to exploit the regularity that is still there to be able to carry out efficient computations. One way to exploit regularity in sparse Cholesky is to find supernodes: sets of scalar variables which are eliminated at the same time and assumed to be mutually connected. It is generally desired that the introduction of supernodes should not make the problem less sparse than it was initially, i.e., it should not introduce any nonzero entries in the matrix that weren't there already. One benefit of using supernodes is that the elimination of a supernode can be computed as a dense subproblem, reintroducing some regularity. There are many ways to detect supernodes before doing the numerical calculations of sparse Cholesky factorization, and they may be able to succeed to a varying degree in clumping variables together. One example uses a Bayes Tree [1], which provides maximal clumping (i.e. grouping into cliques) without reducing the sparsity. The Bayes Tree is composed of cliques, which are densely connected subsets of variables. Each clique may have any number of cliques (zero or more) as children, but at most one parent. Each clique corresponds to a supernode which contains the clique's frontal variables: those variables that belong to the clique, but not to its parent. The Bayes Tree is constructed such that a clique's frontal variables will be eliminated before any of its parent's variables.

In general, when eliminating a node (e.g. a clique) during Cholesky Factorization, all the other nodes that the eliminated node was connected to become connected between themselves. The Bayes Tree has an important advantage in that when a node is eliminated, the only node it is connected to is its parent, so it will not connect different nodes together, only the variables inside the parent. Another important property of the Bayes Tree is that each factor from the factor graph can be attached as a child to one of its cliques. Proceeding with elimination in children before parents, the factor can be ignored before its parent is eliminated, but is needed to compute its elimination. The factor's parent will contain all the variables that the factor depends on. The fact that each factor can be treated once and contribute its entire effect to one supernode (its parent) is a key property of the use of a Bayes Tree.

Cholesky factorization proceeds from children to parents in the Bayes Tree. Each variable that is eliminated creates a column in the L matrix. The sparsity patterns for columns created from the same clique are closely related, and this can be exploited when storing the L matrix.

The solution step consists of two parts: forward substitution using L as a system matrix, followed by back substitution using LT as a system matrix. Forward substitution proceeds from children to parents, just like Cholesky factorization does.

Back substitution proceeds from parents to children, and needs the result from the factorization and forward substitution of the root clique before it can start. If the factor graph has several connected components, then each can be treated separately and has its own root clique. To solve the back substitution of a variable, the corresponding L column that was stored during Cholesky factorization is needed.

### SUMMARY

Examples of this disclosure may have certain advantages. For example, methods and apparatus are disclosed in which memory requirements for the input data to linearization are much smaller than for the input data to Cholesky factorization. Additionally or alternatively, in examples of this disclosure, linearization and Hessian calculation may be efficiently performed in the Cholesky factorization step.

One aspect of the present disclosure provides apparatus for determining partial factor matrices (S) for a tree. The tree comprises a plurality of nodes, each node being associated with a clique of one or more variables and having one or more child nodes and/or one or more child factors. The apparatus comprises a first module configured to provide, for a child factor of a selected node of the plurality of nodes and based on estimates of the one or more variables of the clique associated with the selected node, a linearized matrix (A) representing the child factor of the selected node; and a second module configured to provide a Hessian matrix (F) for the child factor of the selected node based on the linearized matrix (A). The apparatus also comprises a third module configured to accumulate the Hessian matrix (F) for each child factor of the selected node and a partial factor matrix (S) of any child node of the selected node to provide an accumulation matrix (P); and a fourth module configured to provide a partial factor matrix (S) for the selected node based on the accumulation matrix (P). The apparatus is arranged or controlled to select each of the plurality of nodes to determine the partial factor matrix (S) of each node.

Another aspect of the present disclosure provides a method of determining partial factor matrices (S) for a tree. The tree comprises a plurality of nodes, each node being associated with a clique of one or more variables and having one or more child nodes and/or one or more child factors. The method comprising, for each node of the plurality of nodes: providing, using a first module, for a child factor of the node and based on estimates of the one or more variables of the clique associated with the selected node, a linearized matrix (A) representing the child factor of the node; providing, using a second module, a Hessian matrix (F) for the child factor of the node based on the linearized matrix (A); accumulating, using a third module, the Hessian matrix (F) for each child factor of the node and a partial factor matrix (S) of any child node of the node to provide an accumulation matrix (P); and providing, using a fourth module, a partial factor matrix (S) for the node based on the accumulation matrix (P).

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 illustrates an example of a factor graph;

FIG. 2 illustrates an example of a Bayes tree;

FIG. 3 illustrates an example of apparatus for determining partial factor matrices for a tree;

FIG. 4 illustrates an example of linearization and Hessian calculation for a factor, followed by factorization of a clique;

FIG. 5 illustrates another example of an apparatus for determining partial factor matrices (S) for a tree;

FIG. 6 illustrates an example of a module for storing each S matrix separately;

FIG. 7 illustrates an example of a module for accumulating a P matrix in a memory;

FIG. 8 illustrates an example of a module for combining the approaches shown in FIGS. 6 and 7; and

FIG. 9 is a flow chart of an example of a method of determining partial factor matrices for a tree.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g. analog and/or discrete logic gates interconnected to perform a specialized function, Application Specific Integrated Circuits (ASICs), Programmable Logic Arrays (PLAs), etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g. digital or analogue) circuitry including but not limited to application specific integrated circuit(s) (ASIC) and/or field programmable gate array(s) (FPGA(s)), and (where appropriate) state machines capable of performing such functions.

Many SLAM algorithms exist, and many software implementations, but they are quite intensive to run on energy and memory constrained devices in real time. The main reason for this is that SLAM algorithms are seriously memory limited. SLAM algorithms require a lot of storage, a high memory bandwidth, and the addressing pattern is irregular. This leads to a high energy cost, since larger memories are more expensive to access, especially if the addressing pattern is irregular.

Previous literature on efficient algorithms is aimed at either CPU implementations or small scale/local mapping. The CPU implementations optimize for high computational speed, whereas in energy and memory constrained devices it is more appropriate to weigh the cost of additional computation against a decrease in total memory bandwidth and storage. A primary optimization goal is therefore to reduce the number of accesses to large memories and arrange the memory accesses to increase spatial-temporal locality. CPU based implementations also suffer from high energy and area overhead per mathematical operation; in comparison, a dedicated hardware accelerator such as examples disclosed herein can exploit the structure of the problem to drastically reduce the overhead.

Computing linearization, Hessian, Cholesky factorization, and back-substitution of SLAM factor graphs (or supernodal structures/trees or Bayes trees based thereon) are expensive and can be slow operations. General purpose CPUs are not optimized for SLAM computations, and software is another layer which slows down computation. Implementing a hardware-based solution computing linearization, Hessian, Cholesky factorization, back-substitution closer to hardware may remove much of the overhead between software and hardware.

Examples of this disclosure propose a dedicated hardware accelerator to accelerate the time- and energy consuming back-end computations in SLAM, to save time and energy compared to a CPU based solution. Examples of this disclosure use an algorithm based on sparse Cholesky factorization, such as Gauss-Newton.

Mathematically, one iteration of the back-end problem can be seen to involve the steps: Linearization->Create Hessian->Cholesky factorization->Back substitution->Retraction. However, the steps Linearization->Create Hessian->Cholesky factorization can be done much more efficiently when combined. This has the potential to reduce memory bandwidth significantly, and thus save energy, as well as saving memory space.

Some examples propose to use a supernodal structure such as a Bayes Tree to carry out the factorization one clique at a time, allowing to combine linearization, Hessian creation, Cholesky factorization and forward solve per clique.

In examples of this disclosure, when using a supernodal structure such as a Bayes Tree to compute the Cholesky Factorization, linearization and Hessian calculation may not be performed as separate steps before the factorization itself. Instead, when factorizing each clique, linearization and Hessian calculation may be performed for each of its child factors. For example, for each factor, the following steps may be performed in hardware:
Read the measurement data and variable estimates that the factor is based on.
Compute the factor's linearization A (a small dense matrix).
Compute the factor's Hessian A^{T}A (also a small dense matrix) and add it to the parent's Hessian.

This may for example exploit the fact that the whole Hessian contribution term from the factor fits inside the parent clique's variables, so that it is enough to read the inputs and compute the Hessian term once during the factorization process.

By going directly from measurements, which may be stored anyway, to the Hessian, memory size and number of memory accesses are reduced, resulting in a faster, smaller and more energy efficient solution.

In some examples, linearization may have several consequences:
Moving from a representation using the original variables to associated delta variables, denoting changes compared to the linearization point, which consists of the values of the original variables used at the time of linearization. (The original variables will be updated during retraction.)
Creating a quadratic optimization problem to be solved: minimize ∥Ax+b∥², where x is the vector of delta variables, A is the Jacobian, and b is a vector representing an offset.

The result of linearization in such examples is the pair (A, b). To simplify notation, we assume that there is a delta variable called the one variable, which is known to have the value one. This allows us to represent the b vector as an extra column in the Jacobian A, multiplying the one variable when evaluating Ax. This additional offset column is propagated through the calculations in some examples and results in an additional row and/or column in F, S, P, and L matrices, such as those referred to below in some examples. When we refer to A or any of the other matrices, the offset row/column may generally be assumed to be included in some examples. With this formulation, forward substitution can be just the part of Cholesky factorization that computes the offset row of the L matrix. Back substitution may use the L matrix including the result of forward substitution to compute the delta variables.

FIG. 2 illustrates an example of a Bayes tree 200. The Bayes tree 200 includes a root node 202 (also referred to as a root clique). The root clique 202 has two child cliques 204 and 206, and hence is a parent of the child cliques 204 and 206. The clique 204 has two child cliques 208 and 210 and one child factor 212. The clique 208 has two child factors 214 and 216, and the clique 210 has one child factor 218. The clique 206 has one child clique 220 and two child factors 222 and 224, and the clique 220 has two child factors 226 and 228. This is merely a representative example, and a tree, supernodal structure or Bayes tree described herein may have any number of nodes or cliques, each having any number of child cliques and/or child factors.

In some examples, the problem is sparse: each factor connects only a few vector variables, usually two. Most variables are not connected to each other. This makes the factor graph of the problem sparse, and in turn makes the system Jacobian matrix A and Hessian A^{T}A sparse, as well as the resulting Cholesky factor matrix L. Examples of this disclosure may exploit sparsity in an efficient way by using a tree such as Bayes Tree that represents the sparsity of L as a tree of cliques.

Each clique may in some examples contain a number of vector variables, some of which may be shared with other cliques. Frontal variables are in the clique, but not in any of its ancestors. These are the variables that the clique will solve for during the back solve step. Separator variables are shared with the clique's parent clique. The clique will pass information about these to its parent during the factorization step, in the form of a marginal factor (S matrix). A clique (other than the root clique) also has up to one parent clique, and a number of child cliques and/or child factors. Operations within cliques are dense in some examples, and the sparsity is captured in the division into cliques.

As indicated above, examples of this disclosure relate to methods and apparatus for determining partial factor matrices, for example of a tree such as a Bayes tree or a tree based on a factor graph. In some examples, a desired end result is to solve a sparse positive semidefinite linear system of equations in order to compute an improved factor graph solution using a Gauss-Newton iteration. To do that, we linearize, compute a sparse Cholesky decomposition, solve the linear system using back substitution, and retract. Therefore, in some examples, it is desired to determine partial factor matrices S in order to compute L matrices (which form the Cholesky decomposition) in order to solve the linear system using back substitution in order to compute the updated estimate.

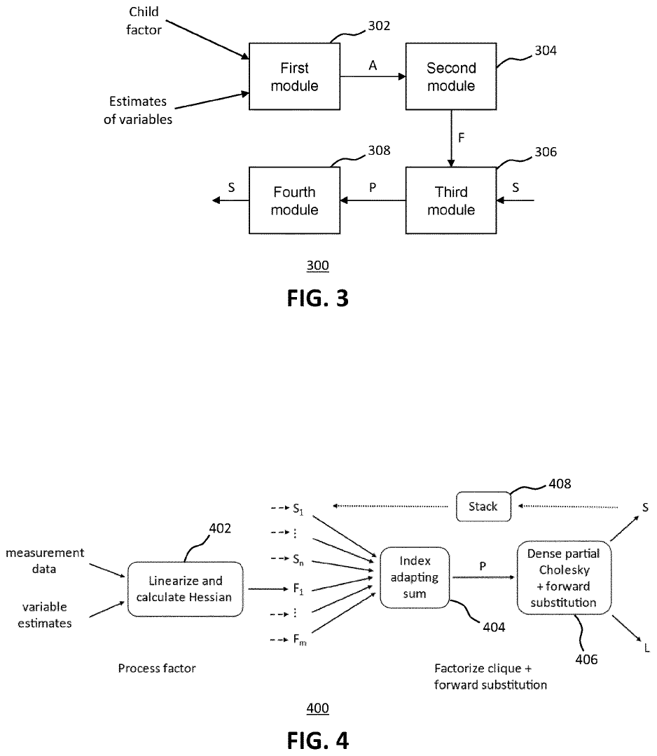

FIG. 3 illustrates an example of apparatus 300 for determining partial factor matrices for a tree, according to examples of this disclosure. The tree, which may be for example a supernodal tree, a Bayes tree, or otherwise a tree based on a factor graph, comprises a plurality of nodes, each node being associated with a clique of one or more variables and having one or more child nodes and/or one or more child factors. The nodes themselves may also be referred to as cliques.

The apparatus 300 comprises a first module 302 configured to provide, for a child factor of a selected node of the plurality of nodes and based on estimates of the one or more variables of the clique associated with the selected node, a linearized matrix (A) representing the child factor of the selected node. Thus, for example, the first module 302 may be configured to receive a child factor of the selected node and estimates of the clique of one or more variables of the selected node, and, in response thereto, compute a linearized matrix A representing the child factor of the selected node.

The apparatus 300 also includes a second module 304 configured to provide a Hessian matrix (F) for the child factor of the selected node based on the linearized matrix (A). Thus, for example, the second module 304 may be configured to receive the linearized matrix A from the first module 302 and, in response thereto, compute a Hessian matrix (F) for the child factor of the selected node. For example, the Hessian matrix may be A^{T}A. Thus, the second module 304 may in some examples be configured to provide the Hessian matrix (F) for the child factor by calculating a transpose of the linearized matrix (A) representing the child factor of the selected node multiplied by the linearized matrix (A) representing the child factor of the selected node, A^{T}A.

A third module 306 is configured to accumulate the Hessian matrix (F) for each child factor of the selected node and a partial factor matrix (S) of any child node of the selected node to provide an accumulation matrix (P). Thus, for example, the third module 306 may be configured to receive the Hessian matrix (F) for each child factor of the selected node and a partial factor matrix (S) of any child node, if any, of the selected node, and in response thereto to compute an accumulation matrix (P) for the selected node. The accumulation matrix (P) may be for example the sum of the Hessian matrix (F) for each child factor of the selected node and the partial factor matrix (S) of any child node of the selected node.

The apparatus 300 also includes a fourth module 308 configured to provide a partial factor matrix (S) for the selected node based on the accumulation matrix (P). For example, the third module 306 may be configured to receive the accumulation matrix P for the selected node and, in response thereto, to compute the partial factor matrix S for the selected node or clique.

The apparatus 300 may be arranged or controlled, for example by a controller (not shown), to select each of the plurality of nodes in the tree to determine the partial factor matrix (S) of each node. Thus a partial factor matrix S of each node or clique in the tree is determined. A controller may for example control the first module, the second module, the third module and the fourth module to determine the partial factor matrix (S) of each of the plurality of nodes in turn.

In some examples, the third module 306 includes storage configured to store the partial factor matrix (S) of the selected node and/or the Hessian matrix (F) for the child factor of the selected node in storage, and to retrieve the partial factor matrix (S) of any child node (if any) of the selected node from the storage. The third module 306 may also include accumulation apparatus to accumulate, into the accumulation matrix (P), the partial factor matrix (S) of any child node of the selected node in the storage and/or the Hessian matrix (F) of any child factor of the selected node in the storage. In some examples, the partial factor matrix (S) of any child node of the selected node and/or the Hessian matrix (F) of any child factor of the selected node is stored in dense form, as explained further below. The storage may comprise a stack for example.

The partial factor matrix (S) of any child node of the selected node and/or the Hessian matrix (F) of any child factor of the selected node may be discarded after being accumulated into the accumulation matrix (P) in some examples. Thus, in further iterations (for example when once again the partial factor matrix S of each node or clique in the tree, or the Hessian matrix F, is determined after variable estimates have been updated) the partial factor matrix S of any child node(s) and/or the Hessian matrix (F) of any child factor(s) will be recalculated, though this may save considerable memory space and access.

The third module 306 may in some examples be configured to expand the dense form of the partial factor matrix (S) of any child node of the selected node and/or the Hessian matrix (F) of any child factor of the selected node based on index information for the child node and/or the child factor to accumulate the partial factor matrix (S) of any child node of the selected node and/or the Hessian matrix (F) of any child factor of the selected node. The index information may indicate for example where the stored values should be located in the expanded matrix S and/or where zero values should be inserted into the expanded matrix S.

The fourth module 308 in some examples is configured to eliminate one or more frontal variables of the one or more variables of the selected node. The fourth module 308 may thus be configured to not eliminate one or more separator variables of the one or more variables of the selected node. The fourth module 308 is configured in some examples to provide, for the selected node, one or more values of a matrix (L), which is referred to in some examples as the Cholesky factor matrix L for the tree. The one or more values of the matrix (L) comprise for example one or more respective columns of the matrix (L) for the selected node, as explained further in illustrative examples below. The fourth module 308 may for example perform a dense partial Cholesky factorization of the accumulation matrix (P).

The apparatus 300 may also include a substitution and retraction module (not shown) configured to determine, for each node, an updated estimate of one or more frontal variables of the one or more variables of the node based on the one or more values of the matrix (L) for the node and, for each node other than a root node, based on an updated estimate of the one or more variables of a parent node of the node. The substitution and retraction block may comprise for example a central processing unit (CPU). The updated estimate of the variables may in some examples be used to determine a further estimate of the variables in the tree using the apparatus 300.

Examples of this disclosure may exploit parallelization to improve performance. For example, the first module 302 and second module 304 may be configured to simultaneously determine the linearized matrix (A) representing a first child factor of the selected node and the Hessian matrix (F) for a second child factor of the selected node. Alternatively, for example, the second module 304 and third module 306 may be configured to simultaneously determine the Hessian matrix (F) for a first child factor of the selected node and accumulate the Hessian matrix (F) for a second child factor of the selected node into the accumulation matrix (P). Alternatively, for example, the first module 302, the second module 304 and the third module 306 may be configured to simultaneously determine the linearized matrix (A) representing a first child factor of the selected node and the Hessian matrix (F) for a second child factor of the selected node and to accumulate the Hessian matrix (F) for a third child factor of the selected node into the accumulation matrix (P).

In some examples, the tree such as a Bayes tree may be a sub-tree of a larger tree (e.g. a larger Bayes tree) that includes multiple sub-trees, where the root nodes of each sub-tree is a node in the larger tree. Thus, for example, the apparatus 300 is further arranged or controlled to select each of a plurality of nodes of each of one or more further sub-trees to determine the partial factor matrix (S) of each node of the further sub-tree, wherein the further sub-tree comprises a plurality of further nodes, each further node being associated with a further clique of one or more further variables and having one or more further child nodes and/or one or more further child factors. Splitting the tree into sub-trees in this way may in some examples further reduce requirements regarding memory and energy expenditure.

Particular example embodiments of the apparatus 300 will now be described for illustrative purposes.

The Bayes tree 200 illustrated in FIG. 2 (and more generally the tree referred to above with respect to the apparatus 300 of FIG. 3) may have the following properties:
Each clique may have one or more children, but only a single parent.
   Children may be cliques and/or factors.
Factors have no children and always a single parent, which is a clique.
The apparatus eliminates, in each clique, a number of variables called its frontal variables; the remaining variables are called the separator variables and are shared with the parent.
Data flow during factorization proceeds from children to parents.
   Factorization of each clique also produces parts of the L matrix; the L output of all cliques constitutes the Cholesky factor matrix that is the output of the Cholesky factorization.

FIG. 4 illustrates an example 400 of linearization and Hessian calculation for a factor, followed by factorization of a clique. Measurement data and variable estimates are used to linearize the factor and to calculate the Hessian (block 402), which may in some examples be performed by the first module 302 and second module 304 of the apparatus 300 shown in FIG. 3. The Hessian F₁ is produced. This Hessian F₁ along with Hessian(s) from any other child factors of the clique (collectively represented in FIG. 4 as F₁ . . . . F_{M}), as well as partial factor(s) S₁ . . . . Sₙ from any child cliques of the clique, if any, are accumulated in index adapting sum block 404, which may be performed by the third module 306 referred to above. Dense Cholesky factorization and forward substitution 406 is performed using P, and provides S for a clique and values (e.g. a column) of L for the clique.

The procedure shown in FIG. 4 may be used multiple times for a tree, and may implement sparse Cholesky factorization. Intermediate data that is passed from a clique (referred to here as a child clique) to the child clique's parent clique is the child clique's marginal factor represented by the symmetric matrix S, along with the child's contribution to the y vector, which can be seen as another row/column of the S matrix. This data could be stored so that it can be easily accessed again, as it is likely to be needed soon. A stack 408 may be used for this, and may be for example the storage in the third module 306 referred to above.

A parent clique doesn't see the individual contributions Sⱼ (j=1, . . . n) and Fₖ (k=1, . . . m) to the matrix P that it will factorize; it only sees the sum. The P matrix will have entries corresponding to all pairs of the clique's variables, while the contributions from children may be limited to different subsets of the same variables, and may be differently ordered. So when summing up P, there is a need to adapt the indices of the S and F matrices, when these are stored in dense form.

Since only P is needed for the computation of a clique's partial factor S, a clique's P matrix can be saved in storage (e.g. on the stack 408), instead of the S and F matrices that contribute to it, saving considerable storage space when a clique has many children (factors and/or cliques). In some examples, the P matrix may not be allocated on the stack 408 until the first child needs to add its contribution to it, otherwise the needed stack space may grow for each level in the Bayes Tree, not just for every nested branch (parent with several children).

In some examples, a child clique may need to store its P matrix on the stack while computing and accumulating contributions into the parent's P matrix, but if the child clique's P matrix is deallocated after the parent clique's P matrix is allocated on the stack, this would leave a hole in the stack. To support cases like this while avoiding holes in the stack, two stacks that can grow from opposite ends into the same memory space may be used. The P matrix of a child is allocated to the opposite end of the stack to that of its parent. Then, the child's P matrix may be deallocated independently of allocating the parent's P matrix, avoiding the creation of holes.

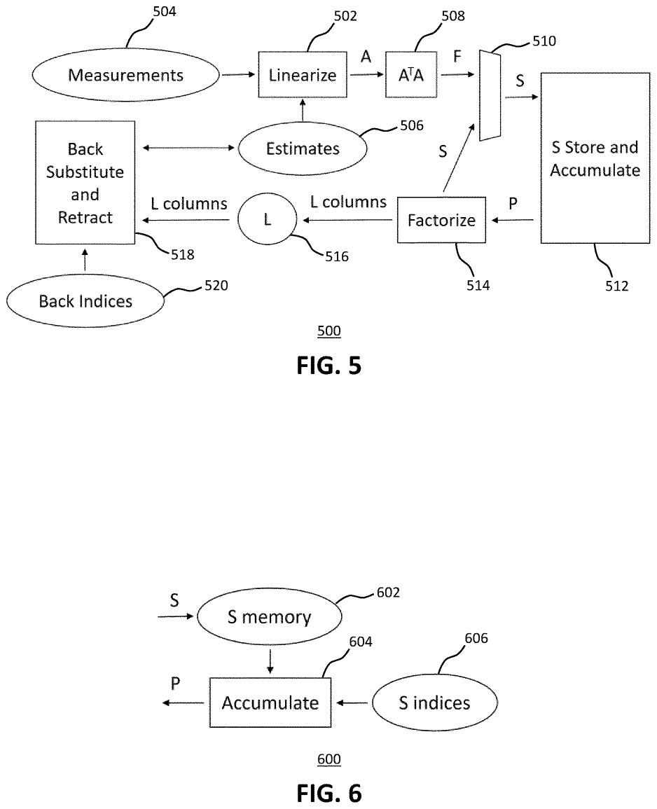

FIG. 5 illustrates another example of an apparatus 500 for determining partial factor matrices (S) for a tree. The apparatus 500 also computes the Cholesky factor matrix L and performs back substitution and retraction to update variable estimates. The apparatus comprises a linearize block 502 (e.g. corresponding to the first module 302 shown in FIG. 3) that receives measurements (factors) 504 and variable estimates 506 and provides, for a child factor of a selected node of the plurality of nodes in a tree, a linearized matrix (A) representing the child factor of the selected node. The estimates 506 may in some examples comprise both original estimates and delta values for the variables. In some examples it may be advantageous to store the estimates in a memory that performs well under random access patterns.

The linearized matrix A is provided to Hessian (A^{T}A) block 508 that determines the Hessian (F) of A and provides F to a multiplexer 510. Hessian block may in some examples correspond to the second module 304 shown in FIG. 3. The multiplexer provides either F or S (partial factor matrix S of any child node(s) in turn) to S Store and Accumulate block 512, which may in some examples correspond to the third module 306 shown in FIG. 3.

In some examples, the Linearize block 502 linearizes one factor at a time. The result (from Hessian block 508) is an F matrix that is passed on to the S Store and Accumulate block 512, to be used to factorize the factor's parent.

S Store and Accumulate block 512 constructs and retrieves P matrices for cliques. Each P matrix can be the sum of a number of S matrices and/or F matrices. These may include additional zero rows and columns added to them by the block 512, where these are stored in dense form. This may be done based on index data, explained further below.

The P matrix from block 512 is provided to factorize block 514, which may in some examples correspond to the fourth module 308 shown in FIG. 3. The factorize block 514 computes a partial dense Cholesky Factorization of the input P matrix. This block may receive information regarding the number of frontal variables nr (to eliminate) and separator nₛ variables (to keep). The factorize block may provide a partial factor matrix S (n_{f}×n_{f}) for the clique that is passed back to S Store and Accumulate block 512. The factorize block also provides n_{f} columns of L to store into L memory 516. This memory can in some examples be large enough to store the entire L matrix, or smaller and closer to the back substitution and retract block and store a subset of L columns until back substitution has used them.

Information (e.g. S matrices, F matrices, P matrix and/or L matrix) could in some examples be stored in a single memory, though in other examples it may be advantageous to maintain memories that are small and accessed frequently or with a random access pattern separate from those that are larger but accessed less frequently and using block-oriented transactions, and storing the different information in the appropriate memory based on access patterns.

A Back Substitute and Retract block 518 performs back substitution for the clique based on columns from L. To solve for all the variables, the whole of L may be used in some examples. This block 518 receives the L columns from L memory 516 and estimates 518 (and/or delta variables, where used) for separator variables in the clique, performs back substitution and retraction, and outputs updated estimates (and delta variables, where used) for frontal variables in the clique.

In some examples, linearization and factorization may be merged into one step. This may use linearize block 502, Hessian block 508, multiplexer 510, S Store and Accumulate block 512 and Factorize block 514.

In some examples, the blocks 502, 508, 510, 512 and 514 may operate on one clique at a time. The A, F, S, and P matrices may be for example dense per clique or per factor matrices, instead of sparse matrices. Together, the per clique/factor matrices may combine to represent the sparse matrices for the whole system. The L columns are also stored per clique, for example in a dense format. The F, S, and P matrices are symmetric in some examples.

By combining linearization and factorization, the intermediate data can be stored in smaller memories in some examples. For example, the data going into the Linearize block 502 may be much smaller than the A or F matrix.

To linearize and factorize the whole system, the blocks shown in FIG. 5 (and the modules described above with reference to FIG. 3) can be invoked multiple times in a computation order that is consistent with the tree (e.g. Bayes Tree). For example, before a clique is factorized, all of its children may be linearized and factorized. When a clique has been factorized, the resulting S matrix may be stored until it can be used to factorize the parent. This can be done using storage in S Storage and Accumulate block 512 for example.

The Factorize block 514 (or the fourth module 308 shown in FIG. 3) performs a dense partial Cholesky factorization for one clique at a time. This partial factorization means that typically not all variables are eliminated. For example, the clique's frontal variables are eliminated, resulting in the L columns which are stored for back substitution, and the clique's separator variables are not eliminated, leaving the S matrix that is returned to S Store and Accumulate block 512 (or third module 306 shown in FIG. 3) to be used to factorize the clique's parent.

The input to the Factorize block 514 (or the fourth module 308 shown in FIG. 3) is the clique's P matrix. This may be for example a sum of the S and/or F matrices from the clique's children. Mathematically, this may be a matrix sum, but the S and/or F matrices may be stored in a dense form. As a result, the different terms in the different matrices can relate to different variables, and therefore may in some examples be translated or converted before they can be summed, for example using the index information referred to above.

An example of this conversion is given below, which also illustrates an example of calculating the P matrix. We want to compute the P matrix for the current clique as the sum of two S matrices from its children, referred to as S and T. S uses the variables x₁₁ and x₂₃, T uses the variables x₁₇ and x₂₃. Both matrices are stored densely, that is, for example, zero rows and columns are not stored. Thus the S and T matrices may be stored in memory as dense matrices S_mem and T_mem, as follows:

$$S\_mem = \begin{matrix}[ s 11 & s 21 \\ s 21 & s 22 ]\end{matrix}$$

$$T\_mem = \begin{matrix}[ t 11 & t 21 \\ t 21 & t 22 ]\end{matrix}$$

In some examples, the S matrices are symmetric, so only the upper or lower triangle is stored for a further memory saving.

To sum S and T, the stored matrices S_mem and T_mem are expanded (or converted) so that common variables are in the same position between matrices. This may be done for example using index information as suggested above. The resulting expanded/converted S and T matrices are then as follows. Missing elements (that is, elements in S and T relating to variables not used by each of those matrices) are assumed to be zeros:

$$S = \begin{matrix}[ s 11 & 0 & s 21 \\ 0 & 0 & 0 \\ s 21 & 0 & s 22 ]\end{matrix}$$

$$T = \begin{matrix}[ 0 & 0 & 0 \\ 0 & t 11 & t 21 \\ 0 & t 21 & t 22 ]\end{matrix}$$

The expanded matrices can then be summed to produce the P matrix, for example as follows, with two columns of L also being produced:

$$P = S + T = \begin{matrix}[ s 11 & 0 & s 21 \\ 0 & t 11 & t 21 \\ s 21 & t 21 & s 22 + t 22 ]\end{matrix}$$

As suggested above, modules and blocks described herein may in some examples be configured or controlled for parallel operation. The following illustrates some examples of parallelization of apparatus disclosed herein:
Some of the modules and blocks can operate in parallel, for example:
   Linearize on one factor at the same time as computing the Hessian (A^{T}A) of a previous factor, S Store and Accumulate on the factor or clique before that, and so on. Alternatively, for example, the same factor could be pipelined through all three modules/blocks.
   Pipelining of the load and factorize steps.
   Factorize on one clique at the same time as S Store and Accumulate on the previous clique, or both pipelined. That is, for example, the apparatus may in some examples be configured such that the fourth module provides the partial factor matrix (S) for the selected node simultaneously with one or more of:
      the first module providing a linearized matrix (A) representing a child factor of a different node of the plurality of nodes (i.e. different to the selected node);
      the second module providing a Hessian matrix (F) for a child factor of a different node of the plurality of nodes; and/or
      the third module providing an accumulation matrix (P) for a different node of the plurality of nodes.
   Modules and blocks can be parallelized internally. For example, each module or block may work on vectors and/or matrices, the sizes depending on the clique sizes. These computations can be parallelized to a degree.
   Multiple instances of each kind of block can be used, and work on independent parts of the tree.

Some particular example embodiments of the third module 306 shown in FIG. 3, or the S Store and Accumulate block 512 shown in FIG. 5, are now described. The memory for S Store and Accumulate block 512 (or third module 306) can be organized as stack for example, for intermediate S matrices that are produced and consumed during the same frame. Some S matrices may also be stored between frames, and therefore in some examples could be stored in another (bigger and slower) memory. These are still used in the frame when they are created, so could also be stored in the stack as well. These can be some or all of the S matrices needed to factorize the parent. However, instead a subset of S matrices may be stored between frames because saving all S matrices in long term storage may be expensive. Thus some S matrices can be stored and others can be recalculated from the saved S matrices and parts of the tree.

In some examples, all S matrices could be stored for possible future use, e.g. for a later frame as suggested above. However, the memory bandwidth and storage space for this could easily be many times that required for the L matrix, and almost all of the stored S matrices will never be reused, though at the time when they are computed, it may not be known which ones will be reused. Therefore, in some examples it may be advantageous to store just a subset of S matrices, and recompute the ones that turned out to be needed by recomputing a subtree rooted in the clique whose S matrix was not stored, where the subtree ends in cliques with stored S matrices. Even though this may increase the overall number of calculations, the overall efficiency and/or speed may be improved due to the lower cost of memory accesses.

FIG. 6 illustrates an example of a module 600 (e.g. third module 306 or S Store and Accumulate block 512) for storing each S matrix separately. When an S or F matrix is produced, it is stored in S memory 602. When a P matrix is needed, an Accumulate block 604 is initialized to a zero P matrix. The module 600 may be configured or controlled to read each contributing S and/or F matrix in turn, together with S (and/or F) indices 606 to translate from the indices used by the stored dense form S and/or F matrix to those used by the target P matrix. For each S and/or F matrix, its row and column indices may be translated and added the corresponding elements in P.

As in some examples P is a symmetric matrix, only P elements pᵢⱼ, where i>=j (or vice versa), may be computed and/or stored. Finally, the accumulated P matrix may be provided, e.g. to the fourth module 308 or Factorize block 514.

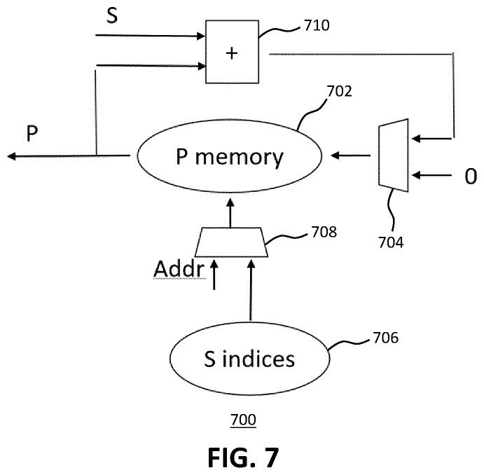

FIG. 7 illustrates an example of a module 700 (e.g. third module 306 or S Store and Accumulate block 512) for accumulating a P matrix in a memory, such as for example a stack. In this example, only P which is the sum of the S and/or F matrices from a clique's children is determined, and the individual S/F matrices are not retained. Space for each P matrix is allocated in P memory 702 when the first S/F matrix that contributes to it starts to be delivered to the module 700. The P matrix is initialized with zeros, if it is not known to be zero already, via multiplexer 704. Each time an S or F matrix is delivered to the module 700 (e.g. from second module 304 or Hessian block 508), S (or F) indices 706 via multiplexer 708 are used to translate the S or F matrix to be added to the P matrix.

For each S (or F) matrix element, the indices are translated, the P element is read at the corresponding position (using an address supplied through multiplexer 708), S/F matrix element is added to the P matrix element using sum block 710 and via multiplexer 704, and the result is stored in P memory 702. When all S and/or F matrices that contribute to a given P matrix have been delivered and accumulated in P in this way, the resulting P matrix can be read from P memory 702 as a dense matrix, and may be provided for example to fourth module 308 or Factorize block 514. In some examples, the P matrix in P memory 702 may also be initialized to zero at this point such that it is ready for a new P matrix to be accumulated in the same memory space (e.g. for a different tree node or clique).

Using the approach of allocating space for a P matrix on the stack when the first contribution to it arrives, in some examples, it could still be possible that a child clique is reading its own P matrix when it wants its parent's P matrix and start to write to it. This situation can be handled for example by using a pair of stacks (e.g. growing from opposite ends of the same memory block), and alternating between the two stacks so that a parent and child's P matrices are allocated in different stacks. This may for example allow pipelining the process of reading a P matrix, factorizing it, and accumulating the resulting S matrix to the stack, without having to store the P or S matrix in between.

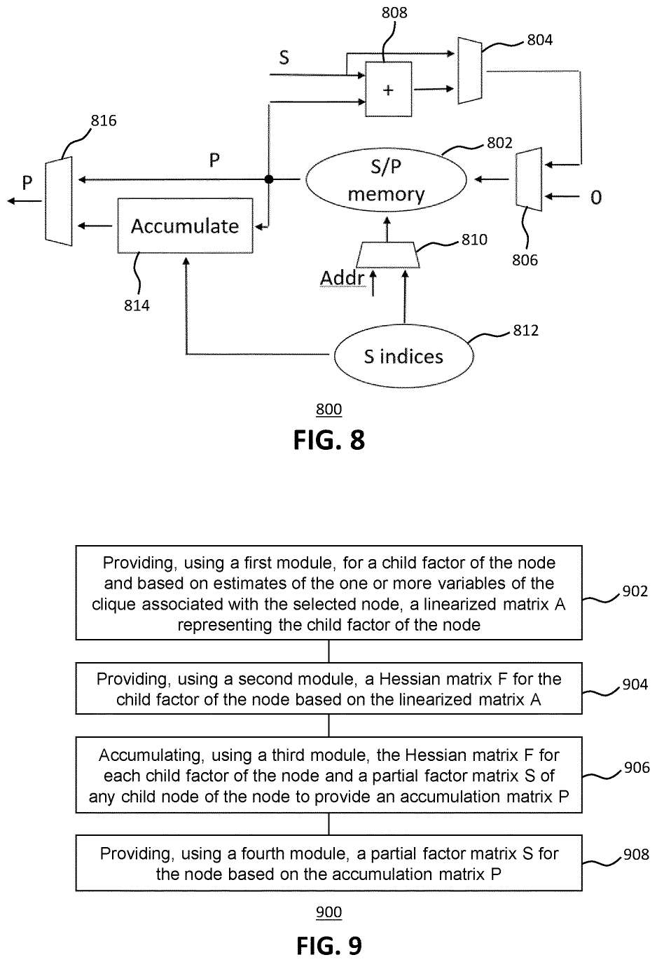

FIG. 8 illustrates an example of a module 800 (e.g. third module 306 or S Store and Accumulate block 512) for combining the approaches shown in FIGS. 6 and 7. Accumulating in the memory as in FIG. 7 often makes better use of memory space than storing S matrices separately, but this approach can't be used for S matrices that could be saved between frames. This is because when saving an S matrix, it may not be known in some examples what it should be added to later. Therefore, FIG. 8 shows a module 800 in which S and F matrices can be stored directly to S/P memory 802, via multiplexers 804 and 806, or accumulated into a P matrix via summing block 808 (which sums P in S/P memory 802 with S and/or F) and multiplexers 804 and 806. Multiplexer 806 can be used to initialize the P matrix in S/P memory 802 to zero. Multiplexer 810 can be used to provide S indices 812 or an address to the S/P memory 802 as in the module 700 shown in FIG. 7.

In some examples, The S/P memory 802 may comprise one stack where intra-frame P matrices are accumulated (this may be a fast memory), and a slower memory where inter-frame S matrices are stored. When a P matrix is read out, it can be used to initialize the state of an Accumulate block 814, which receives P from S/P memory and S indices 812. Then, additional S matrices can be accumulated in the Accumulate block 814 before reading out the P matrix. Multiplexer 816 can select, for the output of the module 800, either P from S/P memory 802 or P from Accumulate block 814.

As indicated above, back substitution and retraction is performed by substitution and retraction module referred to above, or the Back Substitute and Retract block shown in FIG. 5. In some examples, back substitution starts from the root clique of the tree (e.g. Bayes tree) and proceeds towards the leaf cliques. Back substitution for each clique depends on the variable values in the parent clique, and computes the values for the frontal variables in the current clique. For example, back substitution works on delta variables, which indicate how much to change the estimate that is fed into linearization, and computes the frontal delta values based on delta values from the parent clique's variables. When back substitution of a variable is done, retraction can be computed on it without the need for any other variable values. For example, retraction combines delta values with previous estimates to produce updated estimates

In some examples, back substitution and retraction may be performed once for each clique, with parent cliques preceding their children. For each clique, the L columns that were stored when factorizing that clique are read, together with estimates of variables known to the parent clique. Each L column allows back substitution to compute the variable value (e.g. delta value) of one scalar frontal variable, and this may be stored for example in estimates 506 shown in FIG. 5, for example as an updated estimate or a delta value.

Back substitution and retraction are much less computationally intense than factorization, and could in some examples be carried out by a general purpose CPU. However, back substitution still needs to read all the L columns, while retraction only needs to read the updated linear variables.

Back substitution is in some examples essentially the process of solving a linear equation system where the matrix describing the system is triangular. One thing to note is that the variables x mentioned below are what may be referred to as linear variables or delta variables.

In an example of a dense case, it is desired to solve the linear system

$${L}^{T} * x = b$$

where x and b are vectors of length n (x unknown, b known), and L is an n x n lower triangular matrix, that is the entries Lᵢⱼ=0 where i<j. This makes the transposed matrix LT upper triangular. This may be useful because, in some examples, the back substitution step solves the problem L^{T}*x=b.

In an example 2×2 system:

$$x = \begin{matrix}[ x 1 \\ x 2 ]\end{matrix}$$

$$b = \begin{matrix}[ b 1 \\ b 2 ]\end{matrix}$$

$${L}^{T} = \begin{matrix}[ {L}_{11} & {L}_{21} \\ 0 & {L}_{22} ]\end{matrix}$$

so the equation system L^{T}*x=b becomes:

$${L}_{11} * x 1 + {L}_{21} * x 2 = b 1$$

$${L}_{22} * x 2 = b 2$$

This can be solved one step at a time, beginning with the last variable, x2:

$$x 2 = b 2 / {L}_{22}$$

$$x 1 = ( b 1 - {L}_{21} * x 2 ) / {L}_{11}$$

In some examples, back substitution solves one variable xₖ at a time, using the previously solved variables x with higher index, weighting them with the k'th column of L, and finally dividing by the diagonal element Lₖₖ. For child cliques (i.e. cliques other than a root clique), some of the variables xₖ are already known.

Suppose that the root clique is already solved for x3, and now a child clique wants to solve for x1 and x2. The L matrix for the child clique becomes:

$${L}^{T} = \begin{matrix}[ {L}_{11} & {L}_{21} & {L}_{31} \\ 0 & {L}_{22} & {L}_{32} ]\end{matrix}$$

and the equation system for back substitution in the child clique becomes

$${L}_{11} * x 1 + {L}_{21} * x 2 + {L}_{31} * x 3 = b 1$$

$${L}_{22} * x 2 + {L}_{32} * x 3 = b 2$$

Since x3 is already known from back substitution in the parent, we can calculate x2 and then x1. In general, any number of x values already known from the parent may be used—these may have been calculated for the parent or an ancestor.

Some examples assume an additional x variable xₒₙₑ that is always equal to one, and used by all the cliques. This allows us to write the above equation system as:

$${L}_{11} * x 1 + {L}_{21} * x 2 + {L}_{31} * x 3 - b 1 * {x}_{o n e} = 0$$

$${L}_{22} * x 2 + {L}_{32} * x 3 - b 2 * {x}_{o n e} = 0$$

This may allow for example for the removal of the b vector, and represent it using the last row of each L matrix.

In an example sparse case, with a Bayes tree of cliques, it is possible to perform just partial back substitution for the cliques in an order where parents come before children. However, indices should also be considered. In the above examples, variable indices 1 to 3 are used. A given clique will have its own list of variables that it locally considers as x₁ to xₙ, and given that variable ordering, the L matrix will be lower triangular. When fetching values of previously computed x variables (especially ones computed by other cliques), index translation is needed, and this is what the Back Indices 520 in FIG. 5 are used for. The same holds when storing the computed values so that they can be used for solving other cliques.

The following provides additional information regarding an example of retraction (and linearization). The retraction zᵢ⁺ of a given variable depends only on its previous estimate zᵢ and the value of the associated delta variable xᵢ, which was computed by the back substitution step. Let z be the vector of nonlinear variables, where each nonlinear variable zᵢ can itself be a vector of some given size. We want to optimize z to find a more likely estimate given the factor graph on which a tree such as a Bayes tree is based. First, consider a factor that depends on z1 and z2. The cost function associated with this factor is:

$${‖ r ( z 1 , z 2 ) ‖}^{2} ,$$

where r(z1, z2) is the residual function for the factor, which takes z1 and z2 as inputs and returns a vector of residuals, and ∥v∥² means the sum of squares of the elements of the vector v. To linearize the problem, we choose linear variables x1 and x2, and retraction functions R1 and R2. We will use the forward and backward steps to compute values for x1 and x2, and use these to choose new estimates for the nonlinear variables z1⁺ and z2⁺, where:

$$z {1}^{+} = R 1 ( x 1 )$$

$$z {2}^{+} = R 2 ( x 2 )$$

In many cases, we can just have zᵢ⁺=Rᵢ(xᵢ)=zᵢ+xᵢ, but there are some cases where this is not possible. Given R1 and R2, we can linearize r by computing the matrix A and vector b such that:

$$f ( x 1 , x 2 ) = A * x + b \approx r ( z {1}^{+} , z {2}^{+} ) = r ( R 1 ( x 1 ) , R 2 ( x 2 ) )$$

where x contains x1 and x2 stacked, and the left- and right-hand side functions agree in value and derivatives in the point x1=x2=0.

When we have solved for x1 and x2, we know how to compute z1 and z2 using R1 and R2 respectively; this is the retraction step. We see that the retraction zᵢ⁺ of a given variable depends only on the previous estimate zᵢ and the value of the associated linear variable xᵢ.

The retraction function zᵢ⁺=Rᵢ(xᵢ)=zᵢ+xᵢ works well when zᵢ represents an actual vector. In some examples, e.g. SLAM problems, another important kind of nonlinear variable is an orientation in 3d space (e.g. at a given point in a UAV's trajectory, how was it rotated?). Such an orientation has 3 degrees of freedom, but the nonlinear variable z is best described as a four-dimensional vector that is constrained to have length one. In this case, the linear variable x will be 3-dimensional, because z is only free to move in 3 dimensions locally in the neighborhood of a given z value. How z depends on x through R may be chosen so that R(x) remains with length one.

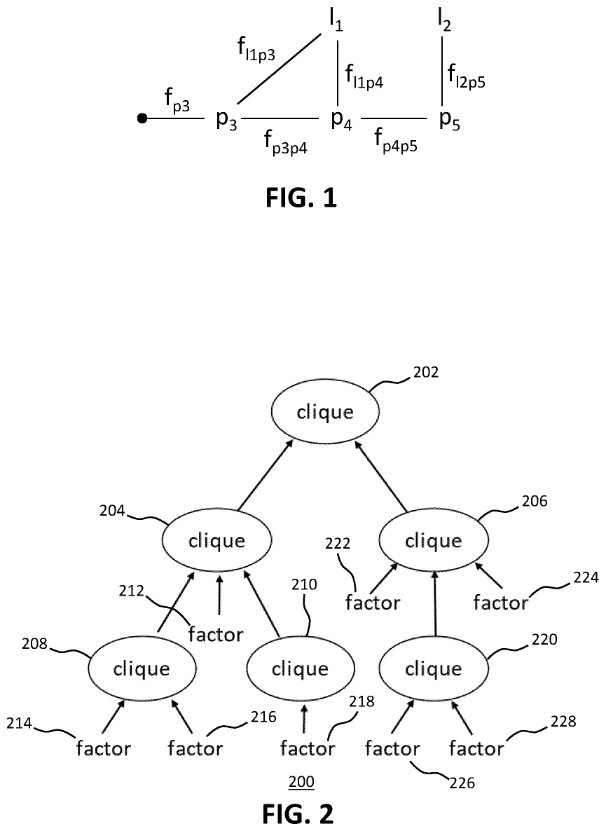

A worked example will now be described of using apparatus disclosed herein, such as for example the apparatus 500 shown in FIG. 5, to update variable estimates in a tree. Consider FIG. 1. This may in some examples be a SLAM problem with three poses p3, p4, p5 corresponding to 3 key frames. Each pose describes position and orientation of a UAV in this example at a given key frame (as well as any velocities, accelerations, and similar that might be needed depending on the nature of the measurements).

The problem also has two landmarks l1 and l2; l1 is seen from poses p3 and p4, while l2 is seen from pose p5. The set of variables is l1, l2, p3, p4, and p5. l1 and l2 are vectors of length nₗ, where nₗ=2 for a 2d problem and 3 for a 3d problem. The pose variables are vectors of length nₚ, at least 3 for a 2d problem and at least 6 for a 3d problem, but up to 15 is not uncommon in 3d problems.

The variables are connected to a number of factors, represented by lines between the variables in FIG. 1:
A prior factor fₚ₃ is connected only to p3
Motion factors fₚ₃ₚ₄ and fₚ₄ₚ₅ connect adjacent poses in the trajectory
Vision factors fₗ₁ₚ₃, fₗ₁ₚ₄, and fₗ₂ₚ₅ connect p3<->l1, p4<->l1, and p5<->l2 respectively

The prior factor has mₚ scalar measurements, the motion factors each have mₚₚ, and the vision factors have mₚₗ·mₚ=2 for a 2d problem and 3 for a 3d problem. mₚₗ might be 1 or 2 for a 2d problem (bearing only or range only, vs both) and 1-3 for a 3d problem (depending of whether we know distance (1 scalar measurement) and/or direction (2 scalar measurements)). The value of mₚₚ depends on the kind of sensors used for the motion measurements.

There may be an additional variable, the one-variable, here called o6, which is a scalar variable that is known to have the value one (or a delta value of 1, as the non-delta value may be irrelevant). By letting each factor depend on this variable implicitly, we simplify the treatment below.

The factor graph represents a cost function in terms of the five variables, where the lowest cost solution (combination of variable values) represents the most likely variable values given the measurements represented by the factors. We assume that we have an initial guess for each variable, and we now want to improve it.

The following provides an example of how a Bayes tree may be constructed from the factor graph shown in FIG. 1. We eliminate one variable at a time; here we choose to begin with l1. Eliminating l1 connects its neighbors p3 and p4 together (in this case they were already connected), forming a clique (a set of variables all directly connected to each other). We then eliminate any additional variables in the clique that are not connected outside of the clique; this holds for p3, but not for p4 since it is connected to p5.

The first clique consists of the first variable we eliminated (l1) and all variables that were connected to it; (l1, p3, p4) in this case. The first clique's frontal variables are the ones that we could eliminate while staying inside of the clique; (l1, p3) in this case, while the remaining variable p4 is a separator variable. We write the clique as (l1, p3: p4), meaning that the clique can solve for l1 and p3 if p4 is known.

In some examples, for each factor, the first clique that eliminates one of the variables connected to that factor becomes the parent of that factor. Eliminating 11 takes the factors fₗ₁ₚ₃ and fₗ₁ₚ₄, and eliminating p3 takes fp₃ and fp₃p₄, so the first clique becomes the parent of the factors fₚ₃, fₚ₃ₚ₄, fₗ₁ₚ₃, fₗ₁ₚ₄.

Next, we eliminate l2, which creates the clique (l2, p5). p5 is connected to p4 and cannot be eliminated now, so the second clique is (l2:p5). The only factor that depends on p5 is fₗ₂ₚ₅, and the second clique becomes its parent.

Next, we eliminate p4, which is connected to p5. p5 is the last remaining variable in the factor graph, and is thus not connected to anything else, so we eliminate it directly after as p4. This final clique thus contains (p4, p5), and has no separator variables, which makes it a root clique, so the third clique is (p4, p5:).

The only remaining factor is fₚ₄ₚ₅, which depends on the clique's eliminated (that is, frontal) variables, so the third clique becomes the parent of fₚ₄ₚ₅.

The third clique was the first clique created to eliminate any of the separator variables of clique 1 (p4) and from clique 2 (p5), so it becomes the parent of these cliques as well. We have now built our Bayes Tree.

We start finding the solution (e.g. updated variable estimates) by selecting clique 1. We could have started with clique 2 instead, but not with clique 3, since we need to visit its children first, so it must be selected after cliques 1 and 2. Then we select clique 2, and finally clique 3.

Clique 1 is the parent of four factors, fₗₚ₃, fₚ₃ₚ₄, fₗ₁ₚ₃, fₗ₁ₚ₄, and before we can factorize the clique, we must compute the clique's P matrix from them. For each child factor in turn, we use the Linearize block 502 for the factor, reading the current values of the variables it depends on from Estimates (p3 for fₚ₃, etc.) and the associated measurement data from Measurements, and producing a Jacobian matrix A. The size of each Jacobian A is m×n, where m is the number of scalar measurements in the corresponding factor, and n is the total number of scalar variables that affect the factor, including the one-variable o6.

The Jacobian of fₚ₃ is Aₚ₃, an mₚ×(nₚ+1) matrix. The Jacobian of fₚ₃ₚ₄ is Aₚ₃ₚ₄, an mₚₚ×(nₚ+nₚ+1) matrix. The Jacobian of fₗ₁ₚ₃ is Aₗ₁ₚ₃, an mₚₗ×(nₚ+nₗ+1) matrix, representing mₚₗ scalar measurements of nₚ+nₗ scalar variables and including an additional offset column associate with the one-variable.

Next, we use the Hessian block 508, passing in the factor's Jacobian A and producing the Hessian F. When A is m×n, F becomes n×n (usually considerably larger than m×n). Fₚ₃ becomes (nₚ+1)×(nₚ+1), Fₗ₁ₚ₃ becomes (nₚ+nₗ+1)×(nₚ+nₗ+1), etc.

The last row and last column of the Hessian (which have identical contents since His symmetric) hold offset data, and is the only part of the Hessian affected by the Jacobian's offset column. The bottom right entry in the Hessian, marked with * below, corresponds to a constant offset in the cost, and is irrelevant since it doesn't affect the result.

We can represent each Hessian as a block matrix:

$${F}_{p 3} = \begin{matrix}[ {G}_{33} & {G}_{36} \\ {G}_{63} & * ]\end{matrix}$$

$${F}_{p 3 p 4} = \begin{matrix}[ {H}_{33} & {H}_{34} & {H}_{36} \\ {H}_{43} & {H}_{44} & {H}_{46} \\ {H}_{63} & {H}_{64} & ⋆ ]\end{matrix}$$

$${F}_{l 1 p 3} = \begin{matrix}[ {I}_{11} & {I}_{13} & {I}_{16} \\ {I}_{31} & {I}_{33} & {I}_{36} \\ {I}_{61} & {I}_{63} & ⋆ ]\end{matrix}$$

$${F}_{l 1 p 4} = \begin{matrix}[ {J}_{11} & {J}_{14} & {J}_{16} \\ {J}_{41} & {J}_{44} & {J}_{46} \\ {J}_{61} & {J}_{64} & ⋆ ]\end{matrix}$$

where indices 1, 3, 4 correspond to l₁, p₃, and p₄; e g, H₄₃ is the part of Fₚ₃ₚ₄ that describes the coupling between p3 and p4 while H₄₄ describes the coupling within p4 for the same factor. Note that the hessians are symmetric, so H₃₄ is the transpose of H₄₃, etc.

Next, we Send the Hessian (F) to S Store and Accumulate block 512, which produces the P matrix for the clique, which is the sum of contributions from each of the clique's child factors (F) and child cliques(S). In this case, for clique 1, we have only child factors.

To represent the P matrix, we use an ordering of the clique's variables. We use the order (l1, p3, p4, o6) which was created when the Bayes Tree was built and has the clique's separator variable(s) last.

To calculate the P matrix, S Store and Accumulate block 512 expands each Hessian to the clique's common variables:

$${F}_{p 3}^{′} = \begin{matrix}[ 0 & 0 & 0 & 0 \\ 0 & {G}_{33} & 0 & {G}_{36} \\ 0 & 0 & 0 & 0 \\ 0 & {G}_{63} & 0 & ⋆ ]\end{matrix}$$

$${F}_{p 3 p 4}^{′} = \begin{matrix}[ 0 & 0 & 0 & 0 \\ 0 & {H}_{33} & {H}_{34} & {H}_{36} \\ 0 & {H}_{43} & {H}_{44} & {H}_{46} \\ 0 & {H}_{63} & {H}_{64} & ⋆ ]\end{matrix}$$

$${F}_{l 1 p 3}^{′} = \begin{matrix}[ {I}_{11} & {I}_{13} & 0 & {I}_{16} \\ {I}_{31} & {I}_{33} & 0 & {I}_{36} \\ 0 & 0 & 0 & 0 \\ {I}_{61} & {I}_{63} & 0 & ⋆ ]\end{matrix}$$

$${F}_{l 1 p 4}^{′} = \begin{matrix}[ {J}_{11} & 0 & {J}_{14} & {J}_{16} \\ 0 & 0 & 0 & 0 \\ {J}_{41} & 0 & {J}_{44} & {J}_{46} \\ {J}_{61} & 0 & {J}_{64} & ⋆ ]\end{matrix}$$

and accumulates the sum:

$$\begin{matrix}P = [ {I}_{11} + {J}_{11} & {I}_{13} & {J}_{14} & {I}_{16} + {J}_{16} \\ {I}_{31} & {G}_{33} + {H}_{33} + {I}_{33} & {H}_{34} & {G}_{36} + {H}_{36} + {I}_{36} \\ {J}_{41} & {H}_{43} & {H}_{44} + {J}_{44} & {H}_{46} + {J}_{46} \\ {I}_{61} + {J}_{61} & {G}_{63} + {H}_{63} + {I}_{63} & {H}_{64} + {J}_{64} & * ]\end{matrix}$$

$$\begin{matrix}= [ {P}_{11} & {P}_{13} & {P}_{14} & {P}_{16} \\ {P}_{31} & {P}_{33} & {P}_{34} & {P}_{36} \\ {P}_{41} & {P}_{43} & {P}_{44} & {P}_{46} \\ {P}_{61} & {P}_{63} & {P}_{64} & {P}_{66} ]\end{matrix}$$

When the clique's P matrix is ready, it is sent from the S Store and Accumulate block 512 to the Factorize block 514, which does a partial factorization. Clique 1 has frontal variables l1 and p3, and separator variable p4 and o6, so the Factorize block 514 should eliminate l1 and p3, but not p4 or o6. The result is the L matrix columns and S matrix for clique 1:

$$\begin{matrix}S = [ {L}_{11} & 0 \\ {L}_{31} & {L}_{33} \\ {L}_{41} & {L}_{43} \\ {L}_{61} & {L}_{63} ]\end{matrix}$$

$$\begin{matrix}S = [ {S}_{44} & {S}_{46} \\ {S}_{64} & * ]\end{matrix}$$

where the diagonal blocks L₁₁ and L₃₃ are lower triangular. The clique's L matrix is stored in the L memory for the backward pass. The S matrix is sent to S Store and Accumulate block 512, where it is stored and will form part of the P matrix for clique 3.

For clique 2, the same steps as for clique 1 apply, but with different variables, factors, and matrices. The only factor is fₗ₂ₚ₅, with Hessian Fₗ₂ₚ₅, which becomes the clique's P matrix:

$$\begin{matrix}P = {F}_{12 p 5} = [ {K}_{22} & {K}_{25} & {K}_{26} \\ {K}_{52} & {K}_{55} & {K}_{56} \\ {K}_{62} & {K}_{65} & * ]\end{matrix}$$

The variable order is (l2, p5, o6). The only frontal variable is l2, and factorization gives the result:

$$\begin{matrix}L = [ {L}_{22} \\ {L}_{52} \\ {L}_{62 ]}\end{matrix}$$

$$\begin{matrix}S = [ {S}_{55} & {S}_{56} \\ {S}_{65} & * ]\end{matrix}$$

The L matrix is saved to L memory and the S matrix is sent to S Store and Accumulate block 512, where it is stored and will form part of the P matrix for clique 3.

Clique 3 depends on two child cliques (cliques 1 and 2) through their S matrices, and one factor fₚ₄ₚ₅. The child cliques'S matrices have already been sent to S Store and Accumulate block 512, but before we can finalize the clique's P matrix, we need to compute the Hessian Fₚ₄ₚ₅:

$$\begin{matrix}{F}_{p 4 p 5} = [ {M}_{44} & {M}_{45} & {M}_{46} \\ {M}_{54} & {M}_{55} & {M}_{56} \\ {M}_{64} & {M}_{65} & * ]\end{matrix}$$

which is done by using the Linearize block 502 and Hessian block 508.

The clique's variable order is (p4, p5, o6). The S Store and Accumulate block 512 will expand the S matrices from cliques 1 and 2 into:

$$\begin{matrix}{S}_{clique 1}^{′} = [ {S}_{44} & 0 & {S}_{46} \\ 0 & 0 & 0 \\ {S}_{64} & 0 & * ]\end{matrix}$$

$$\begin{matrix}{S}_{clique 2}^{′} = [ 0 & 0 & 0 \\ 0 & {S}_{55} & {S}_{56} \\ 0 & {S}_{65} & * ]\end{matrix}$$

to calculate the clique's P matrix:

$$\begin{matrix}{F}_{p 4 p 5} = [ {M}_{44} + {S}_{44} & {M}_{45} & {M}_{46} + {S}_{46} \\ {M}_{54} & {M}_{55} + {S}_{55} & {M}_{56} + {S}_{56} \\ {M}_{64 + {S}_{64}} & {M}_{65} + {S}_{65} & * ]\end{matrix}$$

$$\begin{matrix}= [ {P}_{44} & {P}_{45} & {P}_{46} \\ {P}_{54} & {P}_{55} & {P}_{56} \\ {P}_{64} & {P}_{65} & * ]\end{matrix}$$

which is then factorized as:

$$\begin{matrix}L = [ {L}_{44} & \\ {L}_{54} & {L}_{55} \\ {L}_{64} & {L}_{65} ]\end{matrix}$$

producing an S matrix:

$$S = [ * ]$$

which contains no further information to propagate to the clique's parent, since this is a root clique and doesn't have a parent.

The result after this forward pass is the collection of the L matrices (columns) for cliques 1-3, each representing a part of the system's total L matrix. The system's L matrix in this case is:

$$\begin{matrix}L = [ {L}_{11} & & & & \\ 0 & {L}_{22} & & & \\ {L}_{31} & 0 & {L}_{33} & & \\ {L}_{41} & 0 & {L}_{43} & {L}_{44} & \\ 0 & {L}_{52} & 0 & {L}_{54} & {L}_{55} \\ {L}_{61} & {L}_{62} & {L}_{63} & {L}_{64} & {L}_{65} ]\end{matrix}$$

but is not necessarily explicitly represented or stored in this form; this is just a way to illustrate what the combined contents of the L matrices from cliques 1 to 3 stand for.

The backward pass proceeds from the root clique towards the leaves, solving the back substitution for each parent before its children. We need to start with clique 3, then we will solve clique 2, and finally clique 1. When visiting each clique, we will perform retraction as soon as the results from back substitution are available.

Back substitution calculates the values for the delta variables x1 to x5, corresponding to l1, l2, p3, p4, and p5. We don't need to solve for x6 (corresponding to the one-variable o6), because it is known to be one.

We begin with clique 3 by sending the L matrix for clique 3 to the Back Substitute and Retract block 518. Here, back substitution needs to solve the equation system L^{T}*x=0, where:

$$\begin{matrix}{L}^{T} = [ {L}_{44}^{T} & {L}_{45}^{T} & {L}_{46}^{T} \\ & {L}_{55}^{T} & {L}_{56}^{T} ]\end{matrix}$$

$$\begin{matrix}x = [ x 4 \\ x 5 \\ x 6 ]\end{matrix}$$

giving the system of equations:

$${L}_{44}^{T} * x 4 + {L}_{45}^{T} * x 5 + {L}_{46}^{T} * x 6 = 0$$

$${L}_{55}^{T} * x 5 + {L}_{56}^{T} * x 6 = 0$$

The second equation is solved first to calculate x5, then the first is solved to calculate x4. The Back Substitute and Retract block 518 reads L one column at a time, from the last computed to the first. The block 518 writes x5 and x4 to the Estimates 506 memory, so that they can be used for solving the coming cliques.

The retract part of the block 518 uses the values that were calculated for the linear variables to update the nonlinear variables, updating p4 and p5 in the Estimates 506 memory:

$$p 5 : = {R}_{p 5} ( x 5 )$$

$$p 4 : = {R}_{p 4} ( x 4 )$$

where Rₚ₄ and Rₚ₅ are retraction functions for p4 and p5 respectively, which depend on the type of variable and its previous estimate. The updated estimates can be used to report back to the user, or to start a new iteration to improve the solution, possibly after making some changes to the factor graph.

Now that x5 is known, we have everything needed to calculate x2 and l2, so we send the L matrix for clique 2 to the Back Substitute and Retract block 518, which calculates x2 from the system of equations:

$${L}_{22}^{T} * x 2 + {L}_{25}^{T} * x 5 + {L}_{26}^{T} * x 6 = 0$$

The previously calculated value of x5 is read from the Estimates 506 memory (and x6 is known to be 1). Then the block retracts to update l2 using x2, storing them for example in Estimates 506 shown in FIG. 5.

We send the L matrix for clique 1 to the Back Substitute and Retract block 518, to solve:

$${L}_{11}^{T} * x 1 + {L}_{31}^{T} * x 3 + {L}_{41}^{T} * x 4 + {L}_{61}^{T} * x 6 = 0$$

$${L}_{32}^{T} * x 3 + {L}_{42}^{T} * x 4 + {L}_{62}^{T} ⋆ 6 = 0$$

The previously calculated value of x4 is read from the Estimates 506 memory (and x6 is known to be 1). x3 is calculated first, and then x1. The block retracts to update p3 using x3 and p1 using x1. In this example, we may store both the delta variables and nonlinear variables, x3, x1 and p3, p1, for example in Estimates 506 shown in FIG. 5.

FIG. 9 is a flow chart of an example of a method 900 of determining partial factor matrices (S) for a tree, such as for example a Bayes tree based on a factor graph. In some examples, the method 900 is performed by an apparatus, such as for example the apparatus 300 shown in FIG. 3 or the apparatus 500 shown in FIG. 5. The tree comprises a plurality of nodes, each node being associated with a clique of one or more of the variables and having one or more child nodes and/or one or more child factors. The method 900 is performed for each node of the plurality of nodes.

The method 900 comprises, in step 902, providing, using a first module, for a child factor of the node and based on estimates of the one or more variables of the clique associated with the selected node, a linearized matrix (A) representing the child factor of the node. Step 904 of the method 900 comprises providing, using a second module, a Hessian matrix (F) for the child factor of the node based on the linearized matrix (A). Step 906 comprises accumulating, using a third module, the Hessian matrix (F) for each child factor of the node and a partial factor matrix (S) of any child node of the node to provide an accumulation matrix (P). Step 908 of the method 900 comprises providing, using a fourth module, a partial factor matrix (S) for the node based on the accumulation matrix (P). The first, second, third and fourth modules may correspond to the first module 302, second module 304, third module 306 and fourth module 308 respectively in some examples. Alternatively, in some examples, the first, second, third and fourth modules may correspond to the Linearize block 502, Hessian block 508, S Store and Accumulate block 512 and Factorize block 514 respectively.

In some examples, steps 902 and 904 may be performed per child factor. Step 906 may be performed once for each child factor and each child clique, and provides a single output P for the clique. Step 908 may be performed once for the clique.

In some examples, the method comprises storing the partial factor matrix (S) of the selected node and/or the Hessian matrix (F) for the child factor of the selected node in storage, and accumulating, into the accumulation matrix (P), the partial factor matrix (S) of any child node of the node in the storage and/or the Hessian matrix (F) of any child factor of the node in the storage to provide the accumulation matrix (P). The partial factor matrix (S) of any child node of the node and/or the Hessian matrix (F) of any child factor of the node may be stored in dense form, for example as described above. The storage may be implemented as a stack.

The method 900 may in some examples comprise discarding the partial factor matrix (S) of any child node of the node and/or the Hessian matrix (F) of any child factor of the selected node after being accumulated into the accumulation matrix (P).

In some examples, the method 900 may include expanding the dense form of the partial factor matrix (S) of any child node of the node and/or the Hessian matrix (F) of any child factor of the node based on index information for the child node and/or child factor to accumulate the partial factor matrix (S) of any child node of the node and/or the Hessian matrix (F) of any child factor of the node.

The method 900 may also in some examples comprise providing, using the fourth module, for the node, one or more values of a matrix (L), referred to herein in some examples as the Cholesky factor matrix L. The one or more values of the matrix (L) may be for example one or more respective columns of the matrix (L) for the node. The method 900 may also comprise determining, using a substitution and retraction module, for each node, an updated estimate of one or more frontal variables of the one or more variables of the node based on the one or more values of the matrix (L) for the node and, for each node other than a root node, based on an updated estimate (e.g. calculated delta value) of the one or more variables of a parent node of the node. The substitution and retraction block could be implemented for example as a central processing unit (CPU).

In some examples, the fourth module performs a dense partial Cholesky factorization of the accumulation matrix (P). The fourth module may be configured to eliminate one or more frontal variables of the one or more variables of the node, and to not eliminate one or more separator variables of the one or more variables of the node.

The method 900 may also include parallelization. Thus, for example, the method 900 may comprise, using the first module and second module, simultaneously determining the linearized matrix (A) representing a first child factor of the node and the Hessian matrix (F) for a second child factor of the node. Alternatively, the method 900 may comprise, for example, using the second module and third module, simultaneously determining the Hessian matrix (F) for a first child factor of the node and accumulating the Hessian matrix (F) for a second child factor of the node into the accumulation matrix (P). Alternatively, the method 900 may comprise, for example, using the first module, the second module and the third module, simultaneously determining the linearized matrix (A) representing a first child factor of the node and the Hessian matrix (F) for a second child factor of the node and accumulating the Hessian matrix (F) for a third child factor of the node into the accumulation matrix (P).

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e., the first or second of such features to occur in time or space) unless explicitly stated otherwise. Steps in the methods disclosed herein may be carried out in any order unless expressly otherwise stated. Any reference signs in the statements shall not be construed so as to limit their scope.

### REFERENCES

1. “iSAM2: Incremental Smoothing and Mapping Using the Bayes Tree”, Michael Kaess, Hordur Johannsson, Richard Roberts, Viorela Ila, John Leonard, and Frank Dellaert

1-47. (canceled)

48. A method for determining partial factor matrices (S) in a tree, wherein the tree comprises a plurality of nodes, each node being associated with a clique of one or more variables and having one or more child nodes and/or one or more child factors, and wherein, for each of the plurality of nodes, the method comprises:
providing, using a first module, for each child factor of the node and based on estimates of the one or more variables of the clique associated with the node, a linearized matrix (A) representing each child factor of the node;
providing, using a second module, a Hessian matrix (F) for each child factor of the node based on the corresponding linearized matrix (A);
accumulating, using a third module, the Hessian matrix (F) for each child factor of the node and a partial factor matrix (S) of each child node of the node, to provide an accumulation matrix (P); and
providing, using a fourth module, a partial factor matrix (S) for the node based on the accumulation matrix (P).

49. The method of claim 48, wherein the method comprises, for each node:
storing the partial factor matrix (S) of the node and/or the Hessian matrix (F) for each child factor of the node in storage; and
accumulating, into the accumulation matrix (P), the partial factor matrix (S) of each child node of the node in the storage and/or the Hessian matrix (F) of each child factor of the node in the storage, to provide the accumulation matrix (P).

50. The method of claim 48, further comprising, for each node, discarding the partial factor matrix (S) of each child node of the node and/or the Hessian matrix (F) of each child factor of the selected node, after being accumulated into the accumulation matrix (P).

51. The method of claim 48, further comprising, for each node, expanding the dense form of the partial factor matrix (S) of each child node of the node and/or the Hessian matrix (F) of each child factor of the node based on index information for the child node and/or child factor, to accumulate the partial factor matrix (S) of each child node of the node and/or the Hessian matrix (F) of each child factor of the node.

52. The method of claim 48, further comprising providing one or more values of a matrix (L) for each node, the providing done via the fourth module.

53. The method of claim 52, wherein the one or more values of the matrix (L) for each node comprise one or more respective columns of the matrix (L) for the node.

54. The method of claim 52, further comprising determining, using a substitution and retraction module, for each node, an updated estimate of one or more frontal variables of the one or more variables of the node based on the one or more values of the matrix (L) for the node and, for each node other than a root node, based on an updated estimate of the one or more variables of a parent node of the node.

55. The method of claim 54, wherein the substitution and retraction block comprises a central processing unit (CPU).

56. The method of claim 48, wherein the fourth module performs a dense partial Cholesky factorization of the accumulation matrix (P) for each node.

57. The method of claim 48, wherein, for each node, the fourth module is configured to eliminate one or more frontal variables of the one or more variables of the node.

58. The method of claim 48, wherein, for each node, the fourth module is configured to not eliminate one or more separator variables of the one or more variables of the node.

59. The method of claim 48, wherein the method comprises, for each node:
using the first module and the second module, simultaneously determining the linearized matrix (A) representing a first child factor of the node and the Hessian matrix (F) for a second child factor of the node;
using the second module and third module, simultaneously determining the Hessian matrix (F) for a first child factor of the node and accumulating the Hessian matrix (F) for a second child factor of the node into the accumulation matrix (P); or
using the first module, the second module and the third module, simultaneously determining the linearized matrix (A) representing a first child factor of the node and the Hessian matrix (F) for a second child factor of the node and accumulating the Hessian matrix (F) for a third child factor of the node into the accumulation matrix (P).

60. The method of claim 48, wherein each node has at least one child node and/or at least one child factor.

61. The method of claim 48, wherein, for each node, the accumulation matrix (P) is the sum of the Hessian matrix (F) for each child factor of the node and the partial factor matrix (S) of each child node of the node.

62. The method of claim 48, wherein the tree comprises a Bayes tree, and wherein the Bayes tree is based on a factor graph.

63. The method of claim 62, wherein the Bayes tree is a sub-tree of a larger sub-tree, and the method further includes selecting each of a plurality of nodes of each of one or more further sub-trees to determine the partial factor matrix (S) of each node of the further sub-tree, wherein the further sub-tree comprises a plurality of further nodes, each further node being associated with a further clique of one or more further variables and having one or more further child nodes and/or one or more further child factors.

64. The method of claim 48, wherein, for each node, the second module is configured to provide the Hessian matrix (F) for each child factor by calculating a transpose of the linearized matrix (A) representing the child factor of the node multiplied by the linearized matrix (A) representing the child factor of the node, A^{T}A.

65. The method of claim 48, wherein, for each node, the fourth module provides the partial factor matrix (S) for the node simultaneously with one or more of:
the first module providing a linearized matrix (A) representing a child factor of a different node of the plurality of nodes;
the second module providing a Hessian matrix (F) for a child factor of a different node of the plurality of nodes; and/or
the third module providing an accumulation matrix (P) for a different node of the plurality of nodes.

66. An apparatus configured to determine partial factor matrices (S) in a tree, wherein the tree comprises a plurality of nodes, each node being associated with a clique of one or more variables and having one or more child nodes and/or one or more child factors, the apparatus comprising circuitry configured as a first module, a second module, a third module, and a fourth module, and wherein, for each node of the plurality of nodes:
for each child factor of the node and based on estimates of the one or more variables of the clique associated with the selected node, the first module is configured to provide a linearized matrix (A) representing each child factor of the node;
the second module is configured to provide a Hessian matrix (F) for each child factor of the node, based on the corresponding linearized matrix (A);
the third module is configured to accumulate the Hessian matrix (F) for each child factor of the node and a partial factor matrix (S) of each child node of the node, to provide an accumulation matrix (P); and
the fourth module is configured to provide a partial factor matrix (S) for the node, based on the accumulation matrix (P).
